(19) United States
(12) Patent Application Publication
(10) Pub. No.: US 2014/0375999 A1
(43) Pub. Date: Dec. 25, 2014

(54) COMPLEX-FISH (FOURIER-TRANSFORM, INTEGRATED-OPTIC SPATIAL HETERODYNE) SPECTROMETER WITH N X 4 MMI (MULTI-MODE INTERFERENCE) OPTICAL HYBRID COUPLERS

(71) Applicant: Katsunari OKAMOTO, Ibaraki (JP)

(72) Inventor: Katsunari OKAMOTO, Ibaraki (JP)

(21) Appl. No.: 14/314,210

(22) Filed: Jun. 25, 2014

Related U.S. Application Data
(60) Provisional application No. 61/839,147, filed on Jun. 25, 2013.

(51) Int. Cl. G01J 3/45

(52) U.S. Cl. CPC G01J 3/45
USPC 356/451

(57) ABSTRACT

An apparatus including a transform spectrometer with n×4 multi-mode interface optical hybrid couplers, wherein n=2 or 4, is herein provided. A transform spectrometer apparatus implemented on a planar waveguide circuit is also provided, including: an input optical signal waveguide for carrying an input optical signal; a plurality of input couplers connected to the input optical signal waveguide, each input coupler capable of sending an output signal; an array of interleaved waveguide Mach-Zehner interferometers (MZI), with each MZI coupled to a respective input coupler and each MZI having at least one MZI waveguide for receiving an output signal; and, a plurality of output coupler portions, each output coupler portion coupled to a respective MZI. Each output coupler portion includes one or more inputs along which the output is received from the MZI, and a plurality of outputs for outputting a plurality of signals.

### CROSS-REFERENCE TO RELATED APPLICATIONS

This Application claims priority to U.S. Provisional Application Ser. No. 61,839,147, filed Jun. 25, 2013, and entitled “Complex-FISH (Fourier-Transform, Integrated-Optic Spatial Heterodyne) Spectrometer with N×4 MMI (Multi-Mode Interference) Optical Hybrid Couplers,” and is related to U.S. Pat. No. 8,098,379 B2, issued Jan. 17, 2012, and U.S. Pat. No. 8,406,580 B2, issued Mar. 26, 2013. Each of these applications and U.S. Letters Patents is hereby incorporated herein by reference in its entirety.

### FIELD OF THE INVENTION

The present invention relates in general to planar lightwave circuits. More particularly, the present invention relates to a planar lightwave, Fourier-transform spectrometer.

### BACKGROUND

High-resolution and miniaturized spectrometers without moving parts have a great potential for use in optical fiber communication networks, environmental sensing and medical diagnostics. The spatial heterodyne spectroscopy (SHS) is an interferometric technique that uses the Fourier transformation of the stationary interference pattern from the Mach-Zehnder interferometers (MZIs). The planar waveguide version of the SHS architecture is one of the key solutions since the MZI array is fabricated on one substrate.

The actual optical delays of the fabricated MZIs are likely to deviate from the designed ones and the phase error frozen in each MZI prevents derivation of the correct spectrum. The development of the signal processing procedure to reveal the correct spectrum is an important issue for its practical applications.

A measurable spectral range by the conventional cosine-FFT (Fast Fourier Transform) method was limited to half of the FSR (Free Spectral Range). The novel planar waveguide SHS configuration that allows us to measure full span of one FSR has been strongly required.

### SUMMARY OF THE INVENTION

The shortcomings of the prior art are overcome and additional advantages are provided through the provision, in one aspect, of an apparatus including a transform spectrometer with n×4 multi-mode interface optical hybrid couplers, wherein n=2 or 4.

In another aspect, provided herein is a transform spectrometer measurement apparatus implemented on a planar waveguide circuit, including: an input optical signal waveguide for carrying an input optical signal; a plurality of input couplers, each input coupler of the plurality of input couplers connected to the input optical signal waveguide, and each input coupler including a coupler output for outputting at least one output signal from the input coupler; an array of interleaved, waveguide Mach-Zehner interferometers (MZI), each MZI of the array of interleaved waveguide MZIs coupled to a respective input coupler of the plurality of input couplers, and each MZI having at least one MZI waveguide for receiving the at least one output signal from the input coupler coupled to the MZI; and, a plurality of output coupler portions of the transform spectrometer measurement apparatus, each output coupler portion of the plurality of output coupler portions coupled to a respective MZI of the array of MZIs, wherein the output coupler portion comprises one or more inputs along which the at least one signal is received from the MZI, and a plurality of outputs for outputting a plurality of signals from the output coupler portion, wherein the number of outputs of the plurality of outputs of the output coupler portion is greater than the number of inputs of the one or more inputs of the output coupler portion.

### BRIEF DESCRIPTION OF THE DRAWINGS

One or more aspects of the present invention are particularly pointed out and distinctly claimed as examples in the claims at the conclusion of the specification. The foregoing and other objects, features, and advantages of the invention are apparent from the following detailed description taken in conjunction with the accompanying drawings in which:

FIG. 1 depicts one embodiment of a configuration of a Fourier-Transform, Integrated-Optic Spatial Heterodyne (FISH) spectrometer with interleaved MZI array to be modified, in accordance with one or more aspects of the present invention;

FIG. 2A depicts one embodiment of an individual MZI, in accordance with one or more aspects of the present invention;

FIG. 2B is a graph of transmittance versus heater power for an MZI, in accordance with one or more aspects of the present invention;

FIG. 3 is a graph of measured effective-index fluctuation in an MZI array, in accordance with one or more aspects of the present invention;

FIG. 4 is a graph of a signal spectrum with correction for measured phase errors, in accordance with one or more aspects of the present invention;

FIG. 5 depicts one embodiment of a complex-FISH spectrometer using 2×4 MMI optical hybrid couplers, in accordance with one or more aspects of the present invention;

FIG. 6 depicts one embodiment of an asymmetrical MZI with a 2×4 MMI optical hybrid coupler, in accordance with one or more aspects of the present invention;

FIG. 7 depicts one embodiment of a 4×4 MMI optical hybrid coupler, in accordance with one or more aspects of the present invention;

FIG. 8 depicts one embodiment of a 2×4 optical hybrid coupler using two 2×2 couplers, in accordance with one or more aspects of the present invention;

FIG. 9 depicts one embodiment of the coupler of FIG. 8 illustrating example physical parameters for the coupler, in accordance with one or more aspects of the present invention; and,

FIG. 10 is a graph of a signal spectrum obtained by a complex-FISH spectrometer, in accordance with one or more aspects of the present invention.

### DETAILED DESCRIPTION OF THE INVENTION

The present invention addresses the problem of, for example, the error in the detected spectrum by the FISH spectrometer and the measurable spectrum span by the spectrometer. For example, the deconvolution technique described as follows.

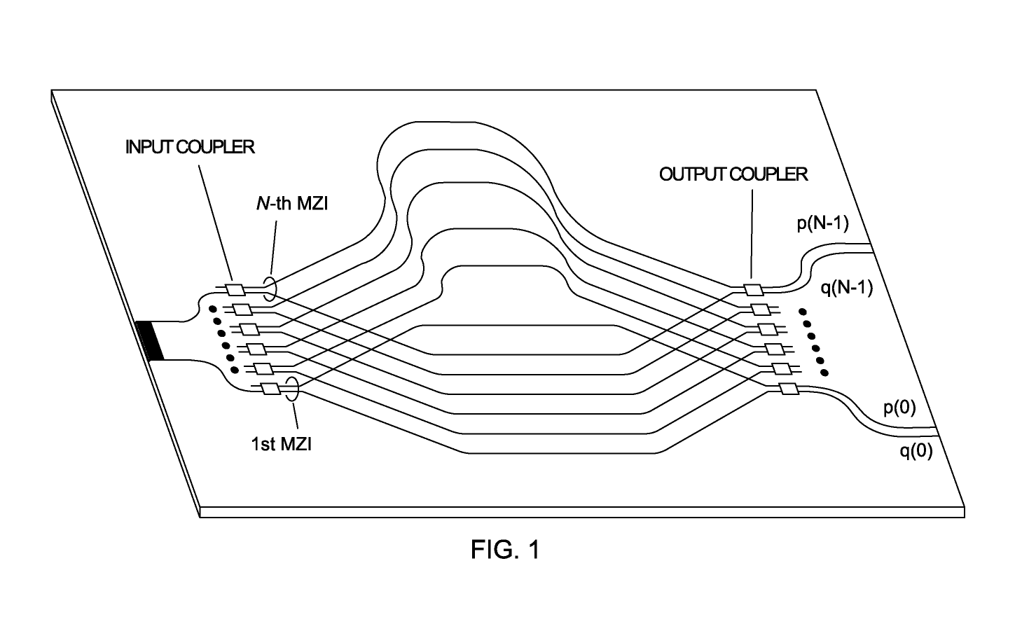

FIG. 1 depicts one embodiment of a configuration of a FISH spectrometer with interleaved MZI array. In a typical spectrometer device, the total number of MZIs is N=32 and path length difference increment is ΔL=162 μm. The waveguide core size is 4.5×4.5 μm² with 1.5% refractive-index difference. The minimum bend radius is 2 mm. White boxes indicate 3-dB couplers consisting of either directional couplers or multimode interference couplers. Waveguide arms in the MZI are intentionally inclined to both sides so that the waveguides intersect by more than 45° with each other. It is known that the excess loss of the waveguide crossing can be reduced as low as ˜0.02 dB/intersection when crossing angle is larger than 45°. Dummy crossing waveguides are placed to make the total number of waveguide crossing equal for all MZIs. Both cross port and through port outputs p(k) and q(k) in the k-th (k=0˜N−1) MZI may be measured so that the spatial non-uniformity of the input light distribution can be corrected. For a signal s (f) passing through the k-th MZI, a normalized cross port output is given by assuming negligible waveguide loss as:

$$P ( k ) = \frac{p ( k )}{p ( k ) + q ( k )} = \frac{1}{S} {\int }_{{f}_{0}}^{{f}_{0} + FSR} s ( f ) \frac{[ 1 + cos ( β k Δ L )}{2} d f \\ ( k = 0 ∼ N - 1 ) , \qquad ( 1 )$$

where β is a propagation constant, FSR is a free spectral range determined by ΔL and s=∫_{f}_{₀}^{f}^{₀}^{+FSR} s(f)df. f₀ is denoted as the Littrow frequency at which phase delays in different MZIs become integer multiples of 2π (β(f₀)ΔL=2mπ). Since MZI response repeats periodically with FSR, the unnecessary spectral range may be blocked by a bandpass filter. Based on the discrete cosine Fourier transform, the input spectrum s(fₙ) (fₙ=f₀+n·FSR/\hat{N} , where \hat{N}=2N) can be calculated from the measured output power P(k) as:

$$s ( {f}_{n} ) = A {\sum }_{k = 0}^{\hat{N} - 1} P ( k ) cos ( 2 π \frac{n k}{\hat{N}} ) ( n = 0 ∼ N - 1 ) . \qquad ( 2 )$$

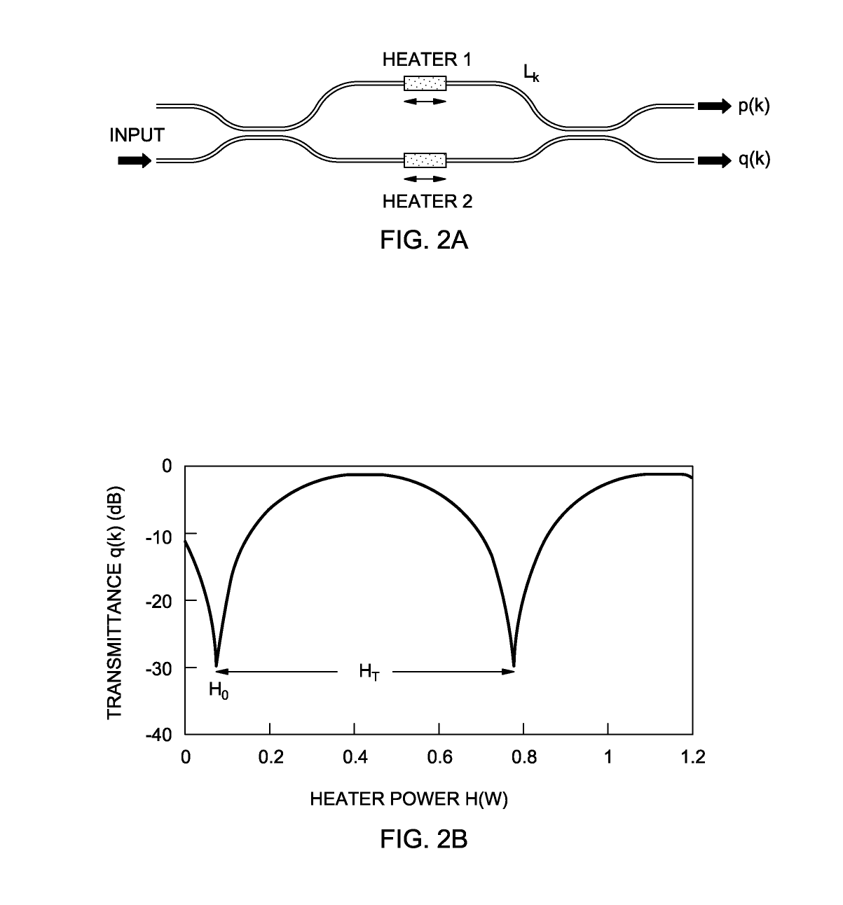

In the above equation (2), A is a constant and P(k) for k=N˜\hat{N}−1 is assumed to be P(\hat{N}−k). Since MZI responses for the signal in the upper half of FSR, s(fₙ) (n=N˜\hat{N}−1), have identical spatial fringe representation to those of the signal in the lower half, only the lower half of the signal spectrum can be measured. Resolution of the spectrometer is given by δf=c/(\hat{N}n_{c}ΔL), where n_{c} and c are effective index of the waveguide and light velocity. Phase errors caused by effective-index fluctuations in the MZI array deteriorate the accuracy in the retrieved signal by Eq. (2). Phase error δφₖ, in the k-th MZI, as depicted by FIG. 2A, is expressed as δφₖ=(2π/λ₀)δn_{c}(k) Lₖ, where δn_{c}(k) and Lₖ denote effective-index fluctuation and MZI arm length. As depicted in FIG. 2A, a heater with length l may be placed from outside of the chip on either one of the MZI arms to measure δφₖ. The through port transmittance q (k) under thermo-optic effect is given by:

$$q ( k ) = \frac{1}{2} \{ 1 - cos \frac{2 π}{{λ}_{0}} [ α H l - δ {n}_{c} ( k ) {L}_{k} ] \} . \qquad ( 3 )$$

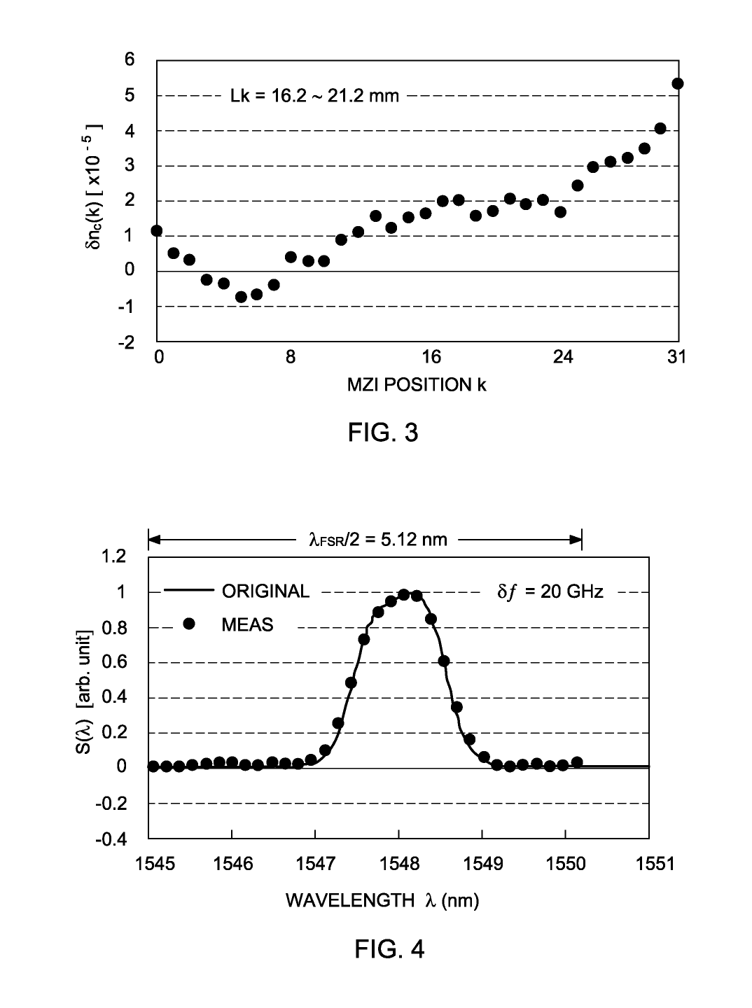

Here H is a heater power applied to the phase shifter, α is a coefficient of thermo-optic refractive index change per unit heater power and λ₀=c/f₀, respectively. FIG. 2B is a graph showing an example of the thermo-optic phase scanning measurement. The first extinction point indicated by H₀ corresponds to the point at which the phase error is compensated for. The power between two adjacent extinction points H_{T} corresponds to an optical path length change with λ₀. δφₖ is then given by δφₖ=2π·H₀/H_{T}. Effective-index fluctuation is obtained as δn_{c} (k)=(δφₖ/Lₖ)λ₀/2π. Measured δn_{c} (k) in the MZI array is shown, for example, in FIG. 3. In the present experiment, N=32, ΔL=162 mm, and λ₀=1550.1 nm, respectively. A discretized form of Eq. (1) including phase errors:

$$P ( k ) = \frac{1}{S} {\sum }_{n = 0}^{N - 1} \frac{s ( {f}_{n} )}{2} [ 1 + cos ( 2 π \frac{n k}{\hat{N}} + δ {φ}_{k} ) ] ( k = 0 ∼ N - 1 ) , \qquad ( 4 )$$

can be solved by N×N simultaneous equations (deconvolution). Signal spectrum corrected with the above procedure is shown in the graph of FIG. 4. The main part of the spectrum is accurately retrieved. Some oscillatory noise features in the peripheral spectral regions may be caused by the imperfection of the deconvolution technique.

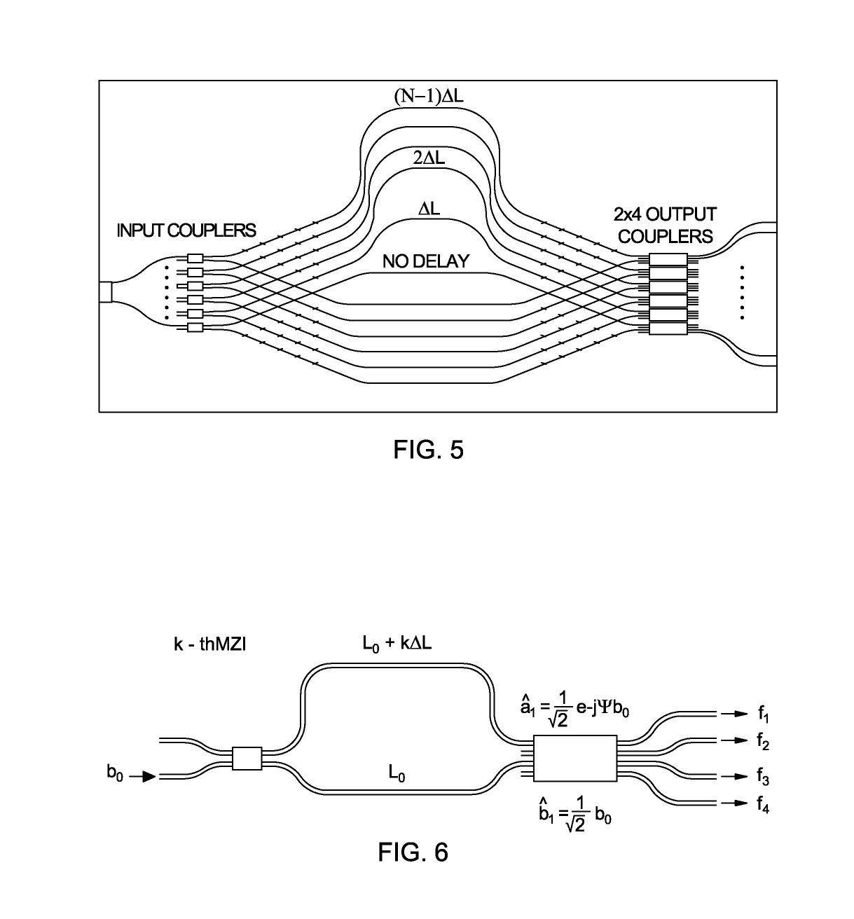

FIG. 5 shows one embodiment of a configuration of a complex-FISH spectrometer with 2×4 MMI optical hybrid couplers. Configuration of the complex-FISH spectrometer is generally similar to the conventional spectrometer as shown in FIG. 1. Points of difference are (1) 2×2 output couplers are replaced by 2×4 couplers and (2) 2N output waveguides are replaced by 4N output waveguides, respectively.

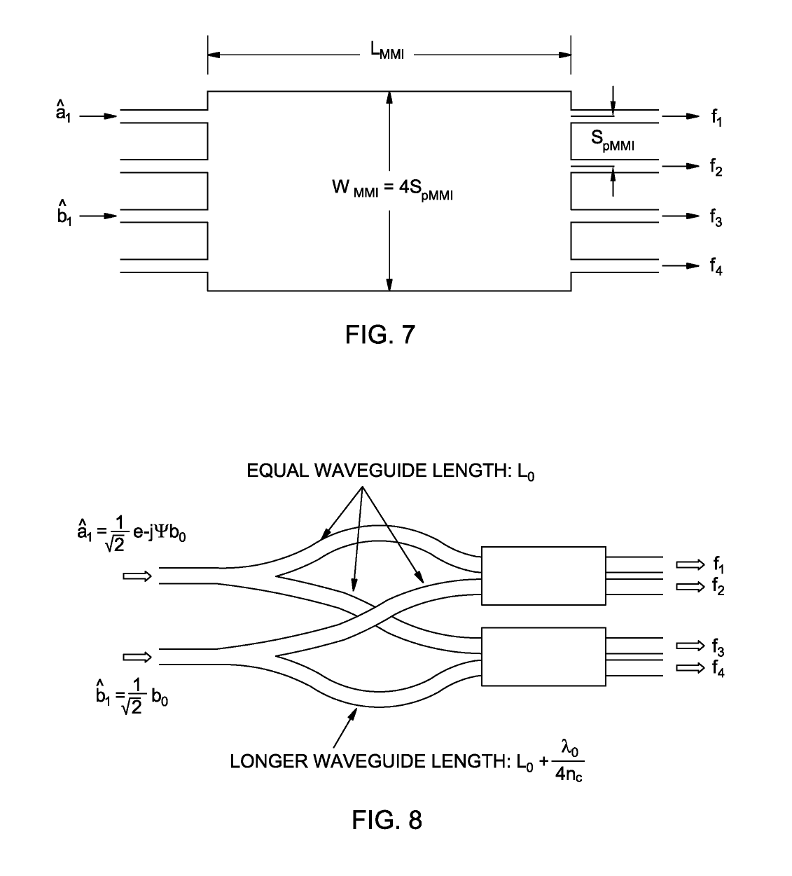

FIG. 6 depicts a schematic configuration of an embodiment of a k-th (k=0˜N−1) asymmetrical MZI with a 2×4 MMI optical hybrid coupler. The fᵢ's in FIG. 6 are output electric fields from the 2×4 coupler. In one embodiment, the 2×4 MMI optical hybrid coupler actually consists of a 4×4 MMI coupler, such as the 4×4 MMI coupler depicted in FIG. 7. Typical geometries of a 4×4 MMI optical hybrid coupler, as in FIG. 7, may be S_{pMMI}=17 μm, W_{MMI}=68 μm, and L_{MMI}=4678.0 μm, respectively.

Differential output from port 1 and 4 is given by:

$$\frac{{\vert {f}_{1} \vert}^{2} - {\vert {f}_{4} \vert}^{2}}{{\vert {f}_{1} \vert}^{2} + {\vert {f}_{2} \vert}^{2} + {\vert {f}_{3} \vert}^{2} + {\vert {f}_{4} \vert}^{2}} = \frac{1}{2} cos ( β k Δ L + \frac{π}{4} ) . \qquad ( 5 \text{-} 1 )$$

Signal in quadrature with respect to (5-1) is obtained from port 2 and 3 as:

$$\frac{{\vert {f}_{2} \vert}^{2} - {\vert {f}_{3} \vert}^{2}}{{\vert {f}_{1} \vert}^{2} + {\vert {f}_{2} \vert}^{2} + {\vert {f}_{3} \vert}^{2} + {\vert {f}_{4} \vert}^{2}} = \frac{1}{2} cos ( β k Δ L + \frac{π}{4} ) . \qquad ( 5 \text{-} 2 )$$

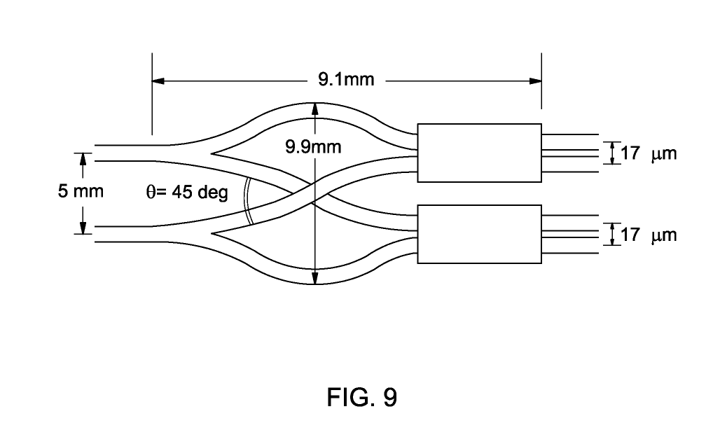

A 2×4 optical hybrid coupler can be constructed by using two 2×2 couplers. FIG. 8 depicts one embodiment of a 2×4 optical hybrid coupler constructed from two 2×2 couplers. In-phase and quadrature-phase outputs are also obtained by using 2×4 optical hybrid coupler using two 2×2 couplers. However, the size of the 2×4 optical hybrid coupler using two 2×2 couplers becomes substantially large, as depicted in FIG. 9. A height of the 2×4 optical hybrid coupler using two 2×2 couplers is almost 150 times larger than that of 4×4 MMI optical hybrid coupler. Then, 4×4 MMI optical hybrid coupler is more advantageous than 2×4 optical hybrid coupler using two 2×2 couplers.

For a signal s (f) passing through the k-th asymmetrical MZI with 2×4 MMI optical hybrid coupler (as depicted by FIG. 6), a normalized in-phase and quadrature-phase outputs are given by:

$$\begin{matrix}\frac{{\vert {F}_{1} \vert}^{2} - {\vert {F}_{4} \vert}^{2}}{{\vert {F}_{1} \vert}^{2} + {\vert {F}_{2} \vert}^{2} + {\vert {F}_{3} \vert}^{2} + {\vert {F}_{4} \vert}^{2}} = \frac{1}{S} {\int }_{{f}_{0}}^{{f}_{0} + FSR} s ( f ) \frac{1}{2} cos ( β k Δ L + \frac{π}{4} ) d f , \\ and & ( 6 \text{-} 1 ) \\ \frac{{\vert {F}_{2} \vert}^{2} - {\vert {F}_{3} \vert}^{2}}{{\vert {F}_{1} \vert}^{2} + {\vert {F}_{2} \vert}^{2} + {\vert {F}_{3} \vert}^{2} + {\vert {F}_{4} \vert}^{2}} = \frac{1}{S} {\int }_{{f}_{0}}^{{f}_{0} + FSR} s ( f ) \frac{1}{2} sin ( β k Δ L + \frac{π}{4} ) d f , \\ where \text{:} & ( 6 \text{-} 2 ) \\ {\vert {F}_{i} \vert}^{2} = {\int }_{{f}_{0}}^{{f}_{0} + FSR} {\vert {f}_{i} \vert}^{2} d f . ( i = 1 ∼ 4 ) . & ( 7 )\end{matrix}$$

Equations (6-1) and (6-2) are discretized for the input spectrum s(fₙ) (fₙ=fₒ+n·FSR/\hat{N} , where \hat{N}=2N) in the form as:

$$\begin{matrix}\begin{matrix}{P}_{k}^{( I )} = \frac{2 ( {\vert {F}_{1} \vert}^{2} - {\vert {F}_{4} \vert}^{2} )}{{\vert {F}_{1} \vert}^{2} + {\vert {F}_{2} \vert}^{2} + {\vert {F}_{3} \vert}^{2} + {\vert {F}_{4} \vert}^{2}} \\ = \frac{{\sum }_{n = 0}^{\hat{N} - 1} {s}_{n} cos ( 2 π \frac{n k}{\hat{N}} + δ {φ}_{k} + \frac{π}{4} )}{{\sum }_{n = 0}^{\hat{N} - 1} {s}_{n}}\end{matrix} \\ ( k = 0 ∼ N - 1 ) , \\ and & ( 8 \text{-} 1 ) \\ \begin{matrix}{P}_{k}^{( Q )} = \frac{2 ( {\vert {F}_{2} \vert}^{2} - {\vert {F}_{3} \vert}^{2} )}{{\vert {F}_{1} \vert}^{2} + {\vert {F}_{2} \vert}^{2} + {\vert {F}_{3} \vert}^{2} + {\vert {F}_{4} \vert}^{2}} \\ = \frac{{\sum }_{n = 0}^{\hat{N} - 1} {s}_{n} sin ( 2 π \frac{n k}{\hat{N}} + δ {φ}_{k} + \frac{π}{4} )}{{\sum }_{n = 0}^{\hat{N} - 1} {s}_{n}}\end{matrix} \\ ( k = 0 ∼ N - 1 ) . & ( 8 \text{-} 2 )\end{matrix}$$

where sₙ=s(fₙ). From Eqs. (8-1) and (8-2), one may obtain the respective real and imaginary parts Uₖ^{(Re)} and Uₖ^{(Im)} of:

$$\begin{matrix}{U}_{k} = \frac{{\sum }_{n = 0}^{\hat{N} - 1} {s}_{n} exp j ( 2 π \frac{n k}{\hat{N}} + δ {φ}_{k} )}{{\sum }_{n = 0}^{\hat{N} - 1} {s}_{n}} , \\ as \text{:} & ( 9 ) \\ {U}_{k} = {U}_{k}^{( Re )} + j {U}_{k}^{( Im )} , & ( 10 \text{-} 1 ) \\ \begin{matrix}{U}_{k}^{( Re )} = \frac{1}{\sqrt{2}} [ {P}_{k}^{( I )} + {P}_{k}^{( Q )} ] \\ = \frac{{\sum }_{n = 0}^{\hat{N} - 1} {s}_{n} cos ( 2 π \frac{n k}{\hat{N}} + δ {φ}_{k} )}{{\sum }_{n = 0}^{\hat{N} - 1} {s}_{n}}\end{matrix} \\ ( k = 0 ∼ N - 1 ) , & ( 10 \text{-} 2 ) \\ \begin{matrix}{U}_{k}^{( Im )} = \frac{1}{\sqrt{2}} [ - {P}_{k}^{( I )} + {P}_{k}^{( Q )} ] \\ = \frac{{\sum }_{n = 0}^{\hat{N} - 1} {s}_{n} sin ( 2 π \frac{n k}{\hat{N}} + δ {φ}_{k} )}{{\sum }_{n = 0}^{\hat{N} - 1} {s}_{n}}\end{matrix} \\ ( k = 0 ∼ N - 1 ) . & ( 10 \text{-} 3 )\end{matrix}$$

When it is assumed that the signal spectrum sₙ's are all real values, Uₖ^{(Re)}, Uₖ^{(Im)}, and δφₖ for k=N˜\hat{N}−1 are obtained as:

Uₖ^{(Re)}=U_{\hat{N}-k′}^{(Re)} (11-1)

Uₖ^{(Im)}=−U_{\hat{N}-k′}^{(Im)} (11-2)

δφₖ=−δφ_{\hat{N}-k′} (11-3)

Once the real and imaginary parts of Uₖ for k=0˜\hat{N}−1 are obtained, the signal spectrum {sₙ} may be derived by using the complex inverse Fourier transformation as:

$${s}_{n} = \frac{A}{\hat{N}} {\sum }_{k = 0}^{M - 1} {U}_{k} {e}^{- j δ {φ}_{k}} {s}_{n} exp ( - j 2 π \frac{nk}{\hat{N}} ) \\ ( n = 0 ∼ \hat{N} - 1 ) , \\ where \text{:} A = {\sum }_{n = 0}^{\hat{N} - 1} {s}_{n} . \qquad ( 12 )$$

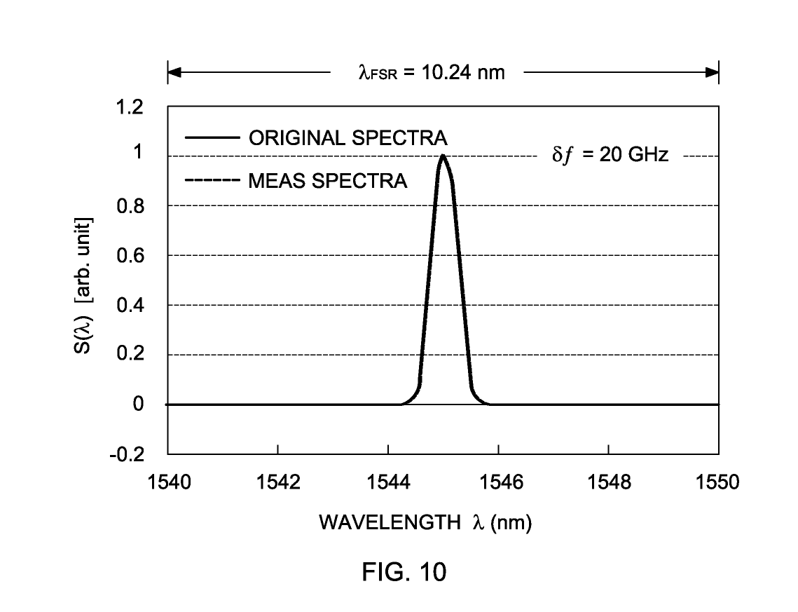

FIG. 10 shows the signal spectrum obtained by the complex-FISH spectrometer with 2×4 MMI optical hybrid couplers, as described herein. Original input spectra are almost completely retrieved over the entire FSR region. It is confirmed that the measurement accuracy and measurement spectral range can be greatly improved over the conventional technique.

To summarize, described hereinabove are certain problems associated with the use of a conventional FISH spectrometer. These problems include: being able to measure only the lower half of the signal spectrum, and deterioration of accuracy in the retrieved signal due to phase errors caused by effective-index fluctuations in the MZI array. Using the deconvolution technique described herein initially can correct the signal spectrum and retrieve the main part of the spectrum accurately. However, such a technique can create oscillatory noise features in the peripheral spectral regions.

As a solution, disclosed herein is the use of a complex-FISH spectrometer with n×4 MMI optical hybrid couplers. In the examples described, n may be 2 or 4. For instance, the conventional 2×2 output couplers of a FISH spectrometer are replaced by 2×4 couplers. In particular, a 2×4 coupler could be constructed using two 2×2 couplers, or alternatively, a 4×4 MMI hybrid coupler. In such an implementation, 2N output waveguides are replaced by 4N output waveguides.

In operation, the differential output may be given from, for instance, ports 1 and 4, by Eq. (5-1), and the signal and quadrature, with respect to Eq. (5-1), may be obtained from ports 2 and 3, by Eq. (5-2). A signal passing through the 2×4 hybrid coupler produces a normalized in-phase and quadrature-phase output. The in-phase and quadrature-phase outputs discretized for the input spectrum to obtain respective real and imaginary parts Uₖ^{(Re)} and Uₖ^{(Im)} (see equations (8-1) and (8-2)). Further, once the real and imaginary parts are obtained, the signal spectrum may be derived using the complex inverse Fourier transform equation. See, in this regard, equations (9), (10-1)-(10-3), (11-1)-(11-3), and (12). Advantageously, the original input spectra may be substantially fully retrieved over the entire FSR region, showing improved accuracy and spectra range over the conventional technique.

Approximating language, as used herein throughout the specification and claims, may be applied to modify any quantitative representation that could permissibly vary without resulting in a change in the basic function to which it is related. Accordingly, a value modified by a term or terms, such as “about,” is not limited to the precise value specified. In some instances, the approximating language may correspond to the precision of an instrument for measuring the value.

The terminology used herein is for the purpose of describing particular examples only and is not intended to be limiting of the invention. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has” and “having”), “include (and any form of include, such as “includes” and “including”), and “contain” (and any form of contain, such as “contains” and “containing”) are open-ended linking verbs. As a result, a method or device that “comprises,” “has,” “includes” or “contains” one or more steps or elements possesses those one or more steps or elements, but is not limited to possessing only those one or more steps or elements. Likewise, a step of a method or an element of a device that “comprises,” “has,” “includes” or “contains” one or more features possesses those one or more features, but is not limited to possessing only those one or more features.

As used herein, the terms “may” and “may be” indicate a possibility of an occurrence within a set of circumstances; a possession of a specified property, characteristic or function; and/or qualify another verb by expressing one or more of an ability, capability, or possibility associated with the qualified verb. Accordingly, usage of “may” and “may be” indicates that a modified term is apparently appropriate, capable, or suitable for an indicated capacity, function, or usage, while taking into account that in some circumstances the modified term may sometimes not be appropriate, capable or suitable. For example, in some circumstances, an event or capacity can be expected, while in other circumstances the event or capacity cannot occur—this distinction is captured by the terms “may” and “may be.”

While several aspects of the present invention have been described and depicted herein, alternative aspects may be effected by those skilled in the art to accomplish the same objectives. Accordingly, it is intended by the appended claims to cover all such alternative aspects as fall within the true spirit and scope of the invention.

What is claimed is:

1. An apparatus comprising:
a transform spectrometer with n×4 multi-mode interface optical hybrid couplers, wherein n=2 or 4.

2. The apparatus of claim 1, wherein the transform spectrometer is fabricated to facilitate measurement of the upper half of the free spectral range.

3. A transform spectrometer measurement apparatus implemented on a planar waveguide circuit, comprising:
an input optical signal waveguide for carrying an input optical signal;
a plurality of input couplers, each input coupler of the plurality of input couplers connected to the input optical signal waveguide, and each input coupler including a coupler output for outputting at least one output signal from the input coupler;
an array of interleaved, waveguide Mach-Zehner interferometers (MZI), each MZI of the array of interleaved waveguide MZIs coupled to a respective input coupler of the plurality of input couplers, and each MZI having at least one MZI waveguide for receiving the at least one output signal from the input coupler coupled to the MZI; and
a plurality of output coupler portions of the transform spectrometer measurement apparatus, each output coupler portion of the plurality of output coupler portions coupled to a respective MZI of the array of MZIs, wherein the output coupler portion comprises one or more inputs along which the at least one signal is received from the MZI, and a plurality of outputs for outputting a plurality of signals from the output coupler portion, wherein the number of outputs of the plurality of outputs of the output coupler portion is greater than the number of inputs of the one or more inputs of the output coupler portion.

4. The transform spectrometer measurement apparatus of claim 3, wherein the number of outputs of the plurality of outputs is twice the number of inputs of the one or more inputs.

5. The transform spectrometer measurement apparatus of claim 3, wherein the output coupler portion comprises a multimode interference (MMI) coupler having a same number of inputs and outputs, wherein the at least one signal received from the MZI comprises t number of signals, wherein the output coupler portion receives the t signals on t number of inputs of the coupler and outputs 2t number of signals on 2t outputs of the MMI coupler.

6. The transform spectrometer measurement apparatus of claim 5, wherein the output coupler portion comprises a 4×4 MMI coupler, wherein the at least one signal received from the MZI comprise two signals, and wherein the output coupler portion receives the two signals on two inputs of the 4×4 MMI coupler and outputs four signals on four outputs of the 4×4 MMI coupler.

7. The transform spectrometer measurement apparatus of claim 3, wherein the output coupler portion comprises a plurality of N×N multimode interference (MMI) couplers, wherein the at least one signal received from the MZI comprises t number of signals, wherein each signal of the t number of signals is split to multiple couplers of the N×N couplers, and wherein the output coupler portion receives the split t number of signals on inputs of the multiple couplers and outputs signals on outputs of the multiple couplers.

8. The transform spectrometer measurement apparatus of claim 7, wherein the output coupler portion comprises first and second 2×2 MMI couplers, wherein the at least one signal received from the MZI comprises two signals, wherein each signal of the two signals is split between an input of the first 2×2 MMI coupler and an input of the second 2×2MMI coupler, and wherein the output coupler portion outputs a signal from each output of the first 2×2 MMI coupler and the second 2×2 MMI coupler.

9. The transform spectrometer measurement apparatus of claim 3, wherein the plurality of input couplers comprises N number of input couplers outputting 2N number of signals, and the plurality of output coupler portions comprises N number of output couplers outputting 4N number of signals.
